(19) United States
(12) Patent Application Publication
(10) Pub. No.: US 2006/0224883 A1
(43) Pub. Date: Oct. 5, 2006

(54) Programming interface for configuring network services in a server

(75) Inventors: Hormuzd M. Khosravi, Portland, OR (US); Suhail Ahmed, Beaverton, OR (US)

Correspondence Address: Daly, Crowley & Mofford, LLP;PortfolioIP, P.O. Box 52050, Minneapolis, MN, 55402, US

(73) Assignee: Intel Corporation

(21) Appl. No.: 11/093,673

(22) Filed: Mar. 30, 2005

(51) Int. Cl. H04L 9/00

(52) U.S. Cl. 713/151

(57) ABSTRACT

A programming interface for Secure Socket Layer (SSL) abstracts manipulation, e.g., configuration and management, of SSL tables based upon an SSL implementation model. The SSL tables can be provided in a forwarding plane. A programming interface for server load balancing (SLB) abstracts configuration and management of SLB tables.

### CROSS REFERENCE TO RELATED APPLICATIONS

Not Applicable.

### STATEMENT REGARDING FEDERALLY SPONSORED RESEARCH

Not Applicable.

### BACKGROUND

As is known in the art, traditionally network services such as Secure Socket Layer (SSL) acceleration, SLB (server load balancing), Stateful Firewall, and content switching have been implemented as stand-alone devices with proprietary hardware and software design/implementation. However, demands in both the enterprise datacenter and in the data network are driving the integration of compute and network processing in order to lower the cost of ownership, enhance security, and enhance over all system performance. Slowing the integration of these services in a non-proprietary way is the lack of standard software application programming interfaces (APIs) to discover, configure and manage these services.

Secure Socket Layer (SSL) has become a widely used mechanism for safeguarding the transmission and reception of Internet data. SSL is used to secure online credit card transactions, World Wide Web page traffic, file and database information, and E-mail exchanges. A typical secure network platform will handle hundreds of megabits per second or more of secure packet bandwidth, and establish thousands of new sessions each second. The computational complexity of such protocols typically requires that cryptographic hardware acceleration be used on platforms that process a large amount of secure network traffic. However, proprietary interfaces can increase the costs to a user.

Server load balancing (SLB) functionality is commonly used in the Internet to improve the performance and scalability of a cluster of servers such as web servers. A SLB device exposes one or more virtual IP addresses to Internet clients and schedules the requests from the Internet clients to the real servers. Some commonly used load-balancing algorithms include round robin, weighted round robin and least number of connections.

Software, system, and network processing element (NPE) vendors desire common application programming interfaces to provide component interoperability. As is known in the art, NPE include various devices for processing packets. NPEs can be programmable to enable operation of protocols and applications. As is also know in the art, NPEs can have an architectural model that includes a management plane managing a control plane, a software API plane, and a forwarding plane. The management plane can include a general purpose processor running software providing an interface to the other planes. The control plane interacts with the forwarding plane to modify forwarding plane operations. And the forwarding plane, which can be implemented on a line card, that performs packet processing functions typically at line rate. NPEs and NPE architectures are discussed more fully in the Network Processing Forum (NPF) Software API Framework Implementation Agreement, Revision 1.0, 2002.

### BRIEF DESCRIPTION OF THE DRAWINGS

The exemplary embodiments contained herein will be more fully understood from the following detailed description taken in conjunction with the accompanying drawings, in which:

FIG. 1 is a block diagram of a modular network device;

FIG. 2 is a block diagram of a network configuration having a SSL proxy with a standardize SSL API;

FIG. 2A is a block diagram showing exemplary SSL architectural relationships;

FIG. 3 is a schematic representation of a SSL full offload model;

FIG. 4 is a pictorial representation of SSL packet flow for a SSL full offload model;

FIG. 5 is a schematic representation of an exemplary embodiment of a SSL partial offload model;

FIG. 6 is a is a schematic representation of a further exemplary embodiment of a SSL partial offload model;

FIG. 7 is a pictorial representation of a SSL packet flow for a SSL partial offload model;

FIG. 8 is a schematic depiction of a network having an SLB application;

FIG. 8A is a block diagram of an SLB functional implementation;

FIG. 8B is a block diagram of a layer 7 functional implementation; and

FIG. 9 is a block diagram of a network configuration having an SLB SAPI.

### DETAILED DESCRIPTION

The following acronyms and abbreviations may be used herein:

| | |
|---|---|
| API | Applications Programming Interface |
| CP | Control Plane |
| FP | Forwarding Plane |
| FAPI | NPF Functional API |
| IETF | Internet Engineering Task Force |
| IP | Internet Protocol |
| Ipv4 | Internet Protocol version 4 |
| Ipv6 | Internet Protocol version 6 |
| LFB | Logical Functional Block |
| NE | Network Element |
| NP | Network Processor |
| NPE | Network Processing Element |
| NPF | Network Processing Forum |
| NPU | Network Processing Unit |
| OpenSSL | An open-source implementation of the SSL/TLS protocol. |
| | It is based on SSLeay. For more information about OpenSSL, |
| | see http://www.openssl.org/. openSSL is used here as an |
| | example application throughout the document. |
| RFC | Request For Comments (IETF standard) |
| SAPI | NPF Service API |
| SCTP | Stream Control Transmission Protocol |
| IM API | NPF Interface Management API |
| PH API | NPF Packet Handler API |

The present application assumes reader familiarity with the following documents:

| NPF Implementation | | |
|---|---|---|
| agreements | Revision | Description |
| NPF SAPI Conv. | 1.0 | Software API Conventions, |
| | | Implementation Agreement |
| NPF Writing Conv. | Final | NPF Writing Conventions |
| NPF Lexicon | 1.0 | NPF API Framework Lexicon, |
| | | Implementation Agreement |
| NPF Framework | 1.0 | NPF Software API Framework, |
| | | Implementation Agreement |
| NPF IM API | Final + 0.3 | NPF Interface Management API |
| NPF IPv4 UFwd | 1.0 | NPF Unicast Forwarding, |
| | | Implementation Agreement |
| NPF Global | | Software Global Definitions - to |
| | | appear |
| NPF IPsec API | 1.0 | IPSec Service API |

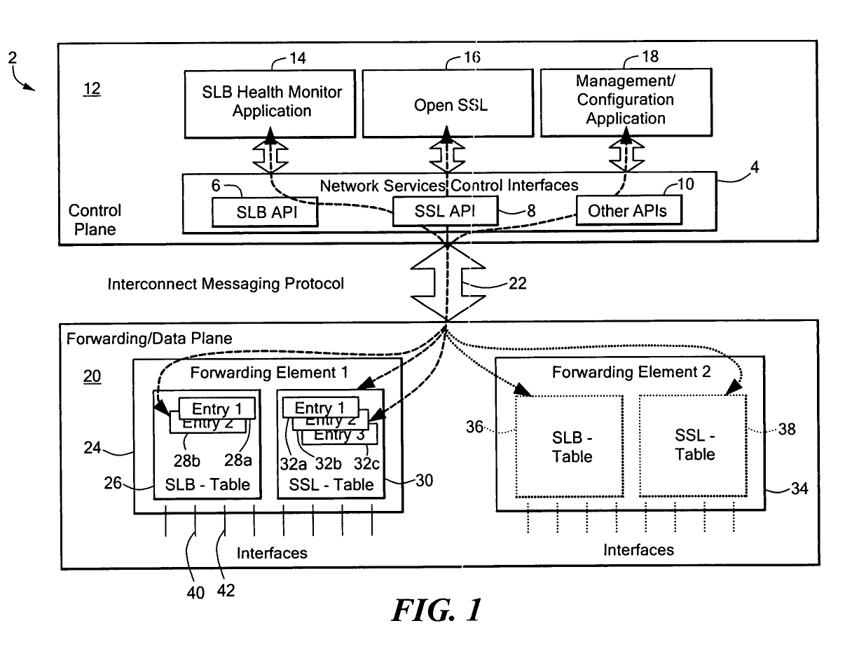

FIG. 1 shows a modular network device 2 having network services control interfaces 4 including SLB service API (SAPI) 6, SSL service API 8, and other API 10 located in a control plane 12. The SLB SAPI 6 provides an interface for an exemplary SLB health monitor application 14, the SSL SAPI 8 provides an interface for an open SSL application 16, and the other API 10 provides an interface for an exemplary management/configuration application 18, all in the control plane 12.

The control interfaces 4 provide a way to target one of many specific network or forwarding elements within a data or forwarding plane 20 via an interconnect messaging protocol 22. A first forwarding element 24 includes an SLB table 26 having a first entry 28a, second entry 28b, etc., and an SSL table 30 having a first entry 32a, second entry 32b, third entry 32c, etc. Similarly, a second forwarding element 34 includes an SLB table 36 and SSL table 38 having respective entries.

A single, specific table entry, e.g., entry 28b, within one of the tables, e.g., SLB table 26, within one of multiple forwarding elements, e.g., first forwarding element 24, may be addressed by an application, e.g., SLB application 14, in the control plane 12. This provides enhanced generality in controlling the specific behavior in network forwarding elements. It is understood that the term table should be construed broadly to include any mechanism to enable look up of application parameter information.

As described in the NPF Software API (SAPI) Framework Implementation Agreement, Revision 1.0, 2002, an architectural model of common network elements typically includes three planes—a control plane, a management plane, and a forwarding plane. Typically, the forwarding plane includes hardware and associated microcode or other high performance software that performs per-packet operations at line rates. The control plane, in contrast, typically executes on a general-purpose processor and is capable of modifying the behavior of forwarding plane operations. The management plane, which provides an administrative interface into the overall system, includes both software executing on a general-purpose processor (including functionality such as a daemon and a web server) as well as probes and counters in the hardware and microcode.

The forwarding/data plane 20 includes forwarding elements, e.g., 24, 34 that can be implemented on line cards or server blades which in turn contain one or more interfaces. Packets come in on an interface, e.g., 40, residing in one forwarding element and go out on another interface, e.g., 42, residing in the same forwarding element or another forwarding element. The forwarding element performs packet processing functionality which includes advanced network services, based on the information contained in various tables, e.g., 26, 30, 36, 38 residing in the forwarding plane 20. The behavior of the forwarding plane 20 depends on the information in the tables.

Applications that reside in the control plane 12 use the control interfaces 4 to add, delete and modify the information in the forwarding plane tables 26, 30, 36, 38. Since there could be more than one table for each forwarding element, the interfaces allows specifying which table in which forwarding element the operation has to take place.

In accordance with one aspect of exemplary embodiments, a set of Services APIs (SAPI) for hardware that offloads the SSL processing, namely the SSL accelerator, is provided. Before described in the interface in detail, some description of SSL is provided below.

Secure Socket Layer (SSL) has become a widely used mechanism for safeguarding the transmission and reception of Internet data. It is being used to secure online credit card transactions, Web page traffic, file and database information, and even email exchanges. A typical secure network platform will handle hundreds of megabits per second or more of secure packet bandwidth, and establish thousands of new sessions each second. The computational complexity of such protocols requires that cryptographic hardware acceleration be used on platforms that process a large amount of secure network traffic. Such hardware is known as the SSL accelerator. Three tables are defined that configure an SSL accelerator: SSL Negotiation (SN) table, SSL Flow (SF) table and the target selector (TS) table. The SSL SAPI enables manipulation, e.g., configuration and/or management of these tables to abstract the underlying SSL services.
SSL Session Negotiation Table: This table contains the session negotiation parameters required to negotiate a successful SSL session with SSL clients. Entries include: proxy interface Address, Server Certificate, cipher/digest list, initial key, Client CA list etc. This database is looked up via the external proxy interface address.
SSL Flow Table: This table contains the flow information associated with each SSL session and is populated dynamically during the session negotiation. Also, once the SSL session is negotiated, a target (server) has to be selected based on some classification (querying into the TSD below), a connection has to be made; this connection information is also part of this database. There is exactly one entry per client connection. The entries include: a flow ID (FID), keying material, bulk cipher used, digest used, client and target server connection identifiers etc. The FID is assigned per client ←→ server connection. The size changes dynamically, as clients go up & down.
SSL Target Selector Table: This gives the target server address. Entries include: target address along with the policy information, namely, proxy external address, layer 7 information (URL) or other proprietary classification information etc. The result of query into this database is a target server address to connect to. (Can be exploited for SSL VPN gateway)

The SSL Service API (SAPI) provides a generic interface for configuring and managing all or a subset of the above tables depending upon the actual distribution model of the SSL. Furthermore, the SSL SAPI allows a client application to receive event notifications indicating packet drops, SSL alerts and other information.

SSL protocol comprises session negotiation and bulk data processing. Depending upon the extent of the SSL functionality offload onto the forwarding planes there can be two main offload options:
SSL Full offload: In this model, both the SSL session and bulk are offloaded to the forwarding plane as shown in figure below. The SAPIs manage the Session Negotiation and the Target Selector tables
SSL Partial offload: SSL partial offload model supports SSL session negotiation in the control plane and the SSL Bulk data processing (Flow Table) in the forwarding plane.

An exemplary list of operations that could be performed with this SSL accelerator Interface is listed below:
1. SSL Event notification registration.
2. Create SN Table
3. Delete SN Table
4. Add session negotiation parameters to the SN Table
5. Delete session negotiation parameters from SN Table
6. Purge all session negotiation entries from SN Table
7. Query session negotiation entries from SN Table
8. Create TS Table
9. Delete TS Table
10. Add SSL target selector entries to the TS Table
11. Delete SSL target selector entries from TS Table
12. Purge all SSL target selector entries from TS Table
13. Query SSL target selector entries from TS Table
14. Encrypt data given the flow info
15. Decrypt data given the flow info
16. Query over all Crypto Statistics
17. Query per SSL session statistics
18. Create SF Table
19. Delete SF Table
20. Add SSL flow parameters to the SF Table
21. Delete SSL flow info from SF Table
22. Purge all SSL flow entries from SF Table
23. Query SSL flow entries from SF Table
   Interfaces 1-17 above are sufficient for SSL full offload model. To support the partial offload model, interfaces 18-23 will be required.

During the SSL session negotiation phase a cipher suite is selected and cryptography keys are exchanged. During the bulk data transfer phase the selected cipher suite is used to encrypt/decrypt the data. In addition, a cryptographic hash is used to validate that the data has not been corrupted. The session negotiation phase uses public key cryptography to pass the keys between the client and server. Both the key exchange and the bulk cryptography are computationally expensive. Since most client machines are single user, the computational complexity does not generally represent a problem for the client machine. However, the server machine can easily become overwhelmed by the cryptographic computations because it may have to do these computations for hundreds or thousands of sessions at a time.

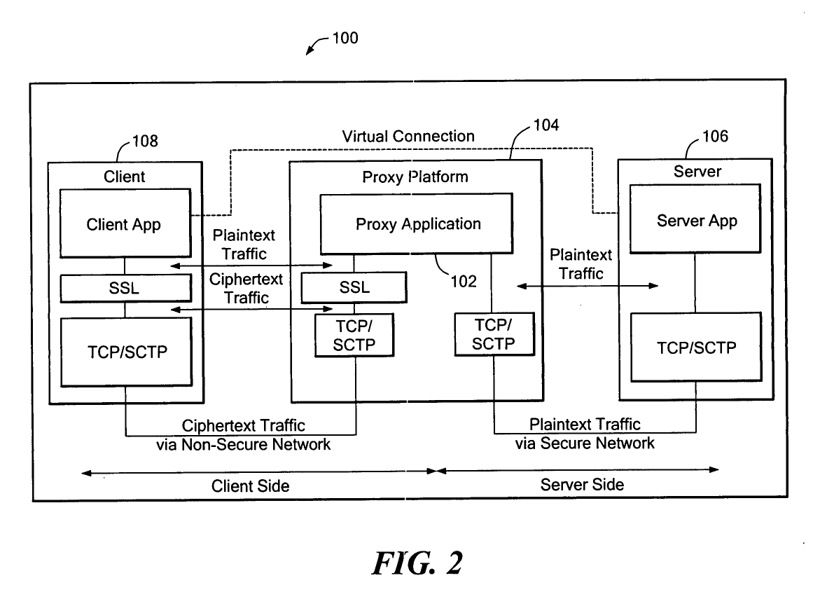

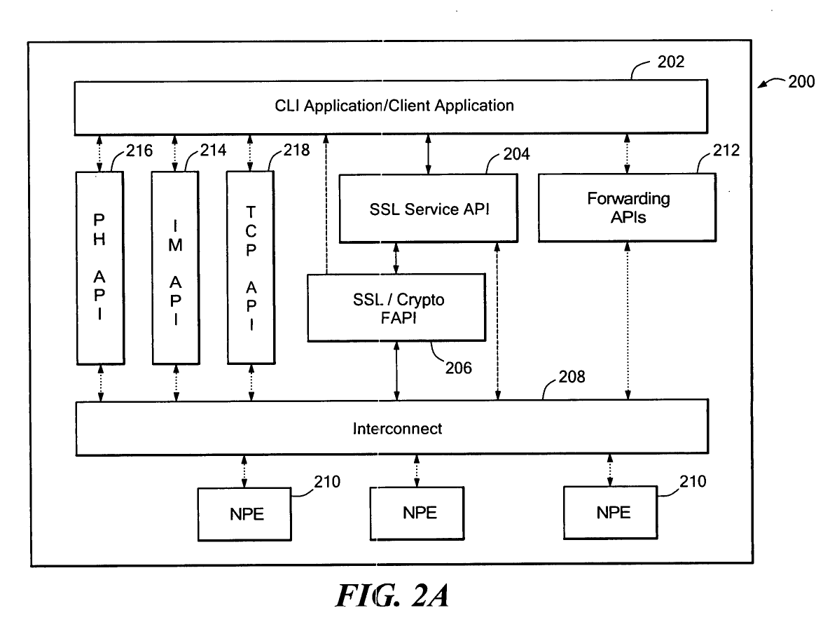

FIG. 2 shows an exemplary SSL acceleration configuration 100 having a SSL acceleration proxy 102. The SSL computations are moved to a separate machine 104 that operates on behalf of a server 106 serving a client 108 to perform the SSL cryptography. The hardware platform 104 for the SSL proxy 102 can be optimized specifically for the task, so the cost per computational cycle is less expensive than for a full-blown server. By using cryptographic acceleration operations in the traffic path near wire speed rates can be achieved instead of having to ship packets to a general purpose CPU for en-/decryption, which is slower and requires transport between CPUs/NPUs.

The side of the SSL Proxy 102 that negotiates with SSL clients in the Internet is the “client side”. Similarly, the side of the SSL proxy 102 that sets up connections to the target servers is the “server side”. Bulk data packets destined to the SSL accelerator from an external SSL client are termed as inbound packets. Similarly, packets originating from an openSSL-based application in the CP or target servers and going out from the interfaces of SSL accelerator are termed as outbound packets.

FIG. 2A depicts an architecture/relationship 200 between the SSL SAPI and higher/lower layer components, in accordance with the NPF API framework. A client application 202 interacts with a SSL service API (SAPI) 204 and an SSL/Crypto FAPI 206, which communicates with an interface 208 for various NPEs 210. Forwarding APIs 212 interact with the client application 202 and the interface 208. Exemplary other APIs include the NPF Interface Management (IM) API 214, NPF packet handler (PH) API 216 and TCP (transfer control protocol) API 218.

The SSL Service API (SAPI) 204 provides a generic interface for configuring and managing all or some subset of the above databases depending upon the distribution model of the SSL. Furthermore, the SSL SAPI 204 allows a client application 202 to receive event notifications indicating packet drops, SSL alerts and other information. In accordance with the NPF framework model, the SSL SAPI 204 is network processor element 210 unaware. That is, the SSL SAPI is independent of network processor being used as a forwarding element.

The SSL protocol comprises session negotiation and bulk data processing. Depending upon the extent of the SSL functionality offload onto the forwarding planes there can be two main offload options: SSL Full offload and SSL Partial offload. The various SSL LFBs referred to in the following sections are as follows:
SSL Session LFB: Responsible for processing the SSL session negotiation with the SSL clients.
SSL Bulk LFB: Responsible for bulk data processing i.e. de-cryption of inbound data and encryption of outbound data.
SSL Proxy LFB: Responsible for interacting with the TCP Offload Engine (TOE) LFBs; accepts incoming connections from the SSL clients, establishes outbound connection to the target servers. Also, feeds packets to session and bulk LFBs.
SSL Re-Director LFB (partially offload): Responsible for redirecting session data to CP via other NPF LFBs (e.g packet handler) and bulk data to SSL bulk LFB.

The SSL LFBs maintain the context of the packet flow via the appropriate shared metadata. For example, the SSL proxy and bulk LFBs can share the flow (or socket) identifier to identify a packet flow.

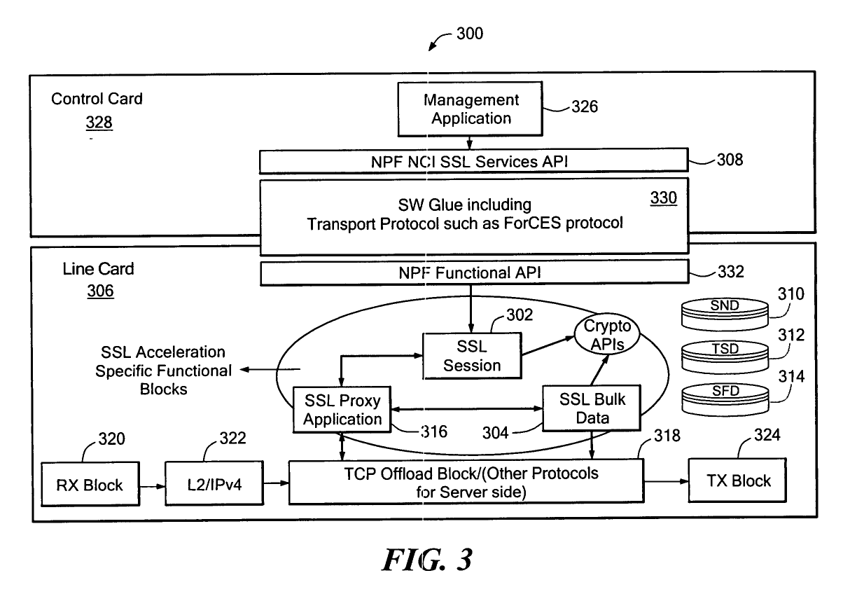

In the SSL Full Offload embodiment 300, both the SSL session 302 and bulk data module 304 are offloaded to the forwarding plane on a line card 306 as shown in FIG. 3. Bulk data refers to a cryptographic technique using bulk ciphers when large quantities of data are to be encrypted/decrypted in a timely manner. Examples include RC2, RC4, and IDEA. The SAPI 308 manage the Session Negotiation 306 and the Target Selector 308 Databases. The SSL Flow Database (SFD) 314 stores flow information associated with each SSL session, as described above. A SSL proxy application 316 interacts with the SSL session 302 and bulk data module 304, as well as a TCP offload block 318. The TCP offload block 318 is part of a data path from a receive block 320, a layer 2 IP protocol version 4 module 322, the TCP offload block 318, and transmit block 324.

A management application 326, which can be provided on a control card 328, communicates with the SSL SAPI 308. A software ‘glue’ module 330 including a transport protocol facilitates communication between the control card 328 and the line card 306. A NPF functional API 332, for example, provides communication between the SSL session 302 and the glue module 330.

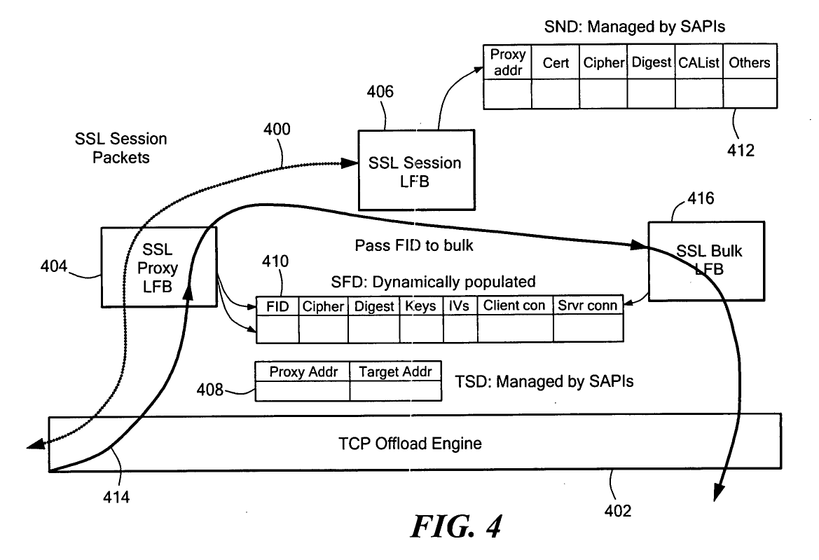

FIG. 4 shows an exemplary packet flow for SSL full offload. The session traffic is handled in the forwarding plane (FP). Typically the bulk data is also handled in the FP as well. Lightly shaded arrows 400 show the SSL session packet flow from the TCP offload engine 402, to the SSL proxy LFB 404, to the SSL session LFB 406. The SSL proxy LFB 404 interacts with the TSD 408 for the proxy address and target address and the SFB 410 for flow information. The SSL session LFB 406 interacts with the SND 412, which is managed by the SAPI, to access session negotiation parameters required to negotiate a successful SSL session with SSL clients.

The dark arrows 414 represent the bulk data flow from the SSL proxy LFB 404, to the SSL bulk LFB 416, to the TCP offload engine 402. The SSL bulk LFB 416 interacts with the SFD 410. In the case of inbound traffic, data is encrypted until the SSL bulk LFB 416 and clear thereafter and vice versa for the outbound traffic. Note that it is possible for a client application to register with a packet handler to receive the inbound bulk data, in which case the bulk data after being processed would be handed to the packet handler LFB.

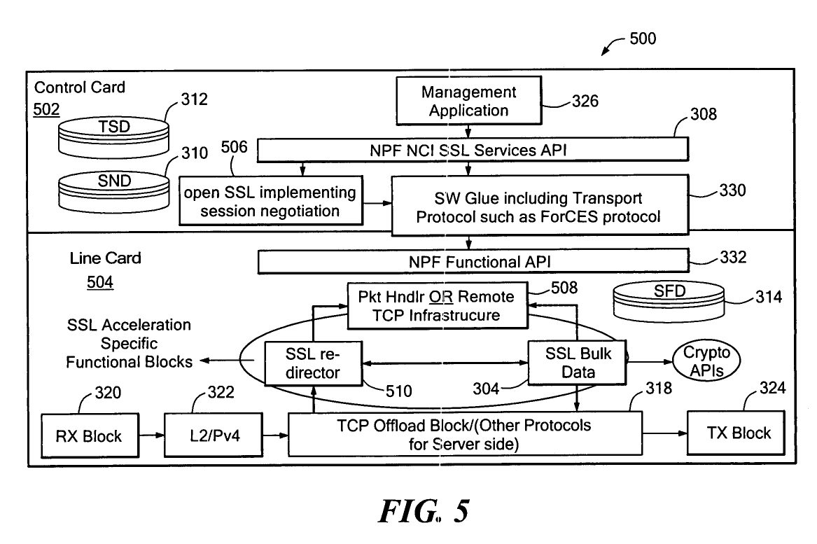

FIG. 5 shows an exemplary SSL Partial offload model supporting SSL session negotiation and SSL bulk data processing in the control plane on a control card 502 and a forwarding plane on a line card 504. It is understood that this model has some functional similarity with the SSL full off load model of FIG. 3 and redundant description is not repeated. In one embodiment, an openSSL-based client application 506 is below the SAPI layer.

In this model, the SSL session 506 resides in the control plane 502 and bulk data processing is offloaded to the forwarding plane 504. As the openSSL based application 506 is below the SAPI layer the SAPIs are the same as the SSL full offload model. The openSSL based application 506 reads the session negotiation information configured via the SAPIs 308. As the session negotiation takes place in the CP 502, the SFD 314 is managed via the FAPIs 332. A packet handler 508 or other remote TCP infrastructure is located on the line card 504 and communicates with an SSL redirector 510 to achieve SSL acceleration in specific functional blocks (not shown) and the SSL bulk data LFB 304.

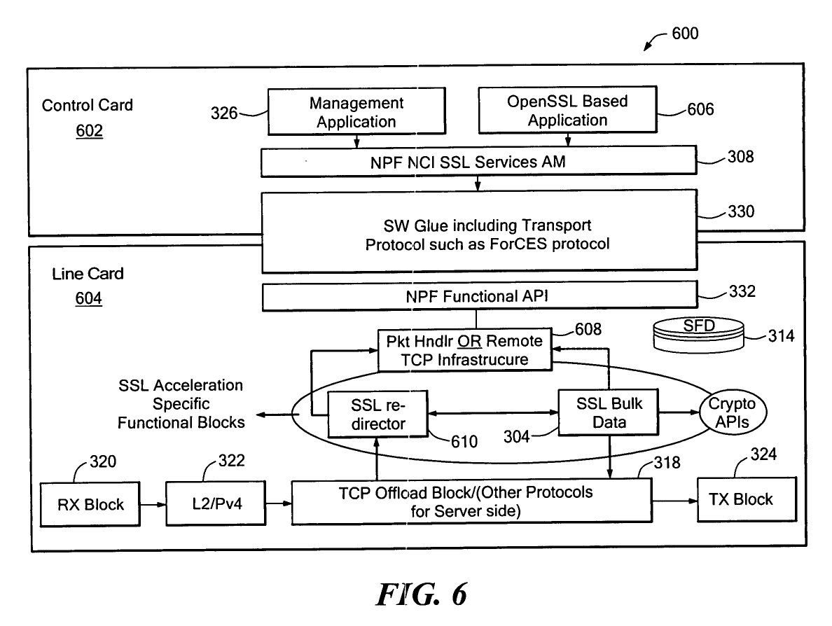

In another embodiment shown in FIG. 6, an openSSL-based client application 506 is above SAPI layer 308. Since the SSL session negotiation processing is above the SAPI layer 308, a SND does not need to be configured. However the SSL flow database (SFD) 314 is exposed to the SAPI layer 308.

When SSL session packets are processed in the CP, the SSL bulk packet flow can take one of two paths. In one path, the bulk packets are processed in the forwarding plane including encryption/de-cryption. Packets are sent to/from client side & server side connections. The bulk data processing is similar to that of the full offload model as shown FIG. 4. One difference is that the SFD is managed via the FAPIs in this case during the session negotiation.

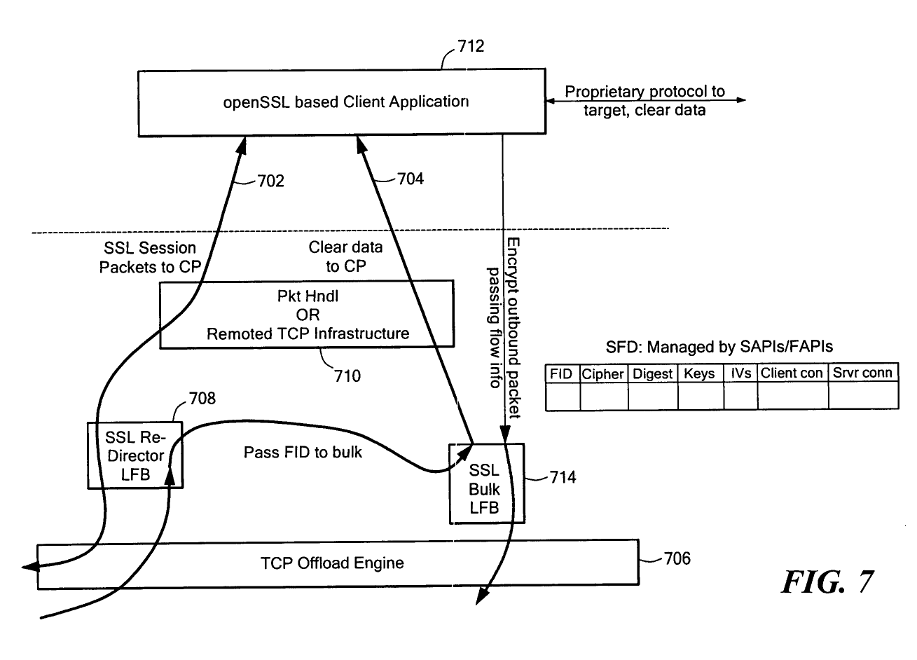

In another path, the inbound bulk packets, after decryption, are directed to the client application in the control plane and the client application redirects to the target side connection (or it may consume the packets). Outbound bulk packets are received by the client application in the CP which then requests the FP for encryption and sending out to the SSL client in the internet. FIG. 7 shows an example SSL packet flow for this partial offload model with bulk data sent to the control plane.

The light arrow 702 represents the SSL session packet flow and the dark arrow 704 represents the bulk data flow. Session traffic flows from the TCP offload engine 706 to the SSL redirector LFB 708 to a packet handler 710 the open SSL-based client application 712 in the control plane. Inbound bulk data flows from the TCP offload engine 706 to the SSL redirector LFB 708 to an SSL bulk data LFB 714 to the open SSL-based client application 710 in the control plane. Packet flow to the control plane is achieved via a packet handler 710 (or the remote TCP infrastructure). It is possible that the TCP is not offloaded to the FP. In this case, all the packets are received by to the application in the CP, which will invoke the SAPIs to get the packets encrypted/decrypted. The outbound traffic is sent via an encrypt SAPI call.

In the application programming interface (API) embodiments described below, the following should be noted:
the structure and attributes of SSL reflect what is needed by the forwarding plane, not by the application. Applications are expected to maintain their own representation of the SSL databases.
Memory allocation and usage model for this API implementation will be as dictated by the NPF Software Conventions Implementation Agreement.
The SSL SAPI is designed in accordance with the NPF framework design principle. Usually control applications need assistance from a number of APIs. In particular the Operational APIs—such as the Interface Management API and the Packet Handler API—are needed by most applications. SSL is no exception. For a usable system, the SSL SAPI is also reliant on the interface management API. Further, for partial offload models the applications will need the TCP APIs.
SSL runs on top of either TCP or SCTP and the server side connection is TCP (or SCTP)
There is one set of session negotiation attributes per proxy (virtual) interface.
Whenever TOE is assumed on the forwarding plane, it is fully operational including infrastructure to support TOE in the Control Plane. Thus, in case the client application resides in the control plane, (partial offload model), this infrastructure provides TCP packet flow into the control plane from forwarding plane. (In other words, it is assumed that a TCP application running on the CP can fully operate with TOE running on the FP)
In case of the partial offload model, the application running on the control plane manages TCP connections both passive (client side) and active (server side).
SSL design could leverage the Server Load Balancing (SLB) functional blocks for the selection of the target server for a particular SSL client request. A simple case of this SSL target selector database (TSD) is described here for full operation of SSL in absence of SLB. In this case, a more elaborate proprietary target selection mechanism can be used by extending the example TSD.
   Server Load Balancing (SLB)

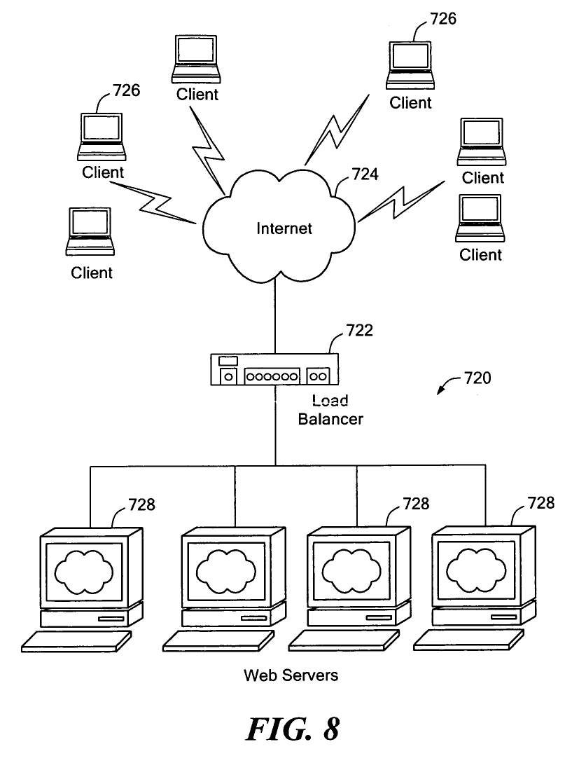

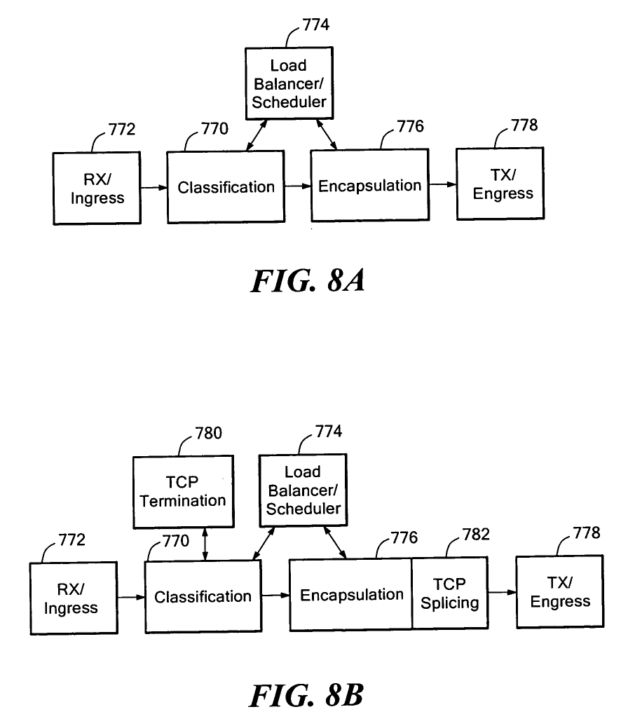

As noted above, server load balancing (SLB) functionality is commonly used in the Internet to improve the performance and scalability of a cluster of servers such as web servers. FIG. 8 shows an exemplary network 720 having an SLB application. A load balancer 722 is coupled to a network 724, such as the Internet, supporting a series of clients 726. The load balancer 722 distributes a load generated by the clients 726, for example, among various web servers 728. The load balancer 722 is located between the clients 726 and the servers 728 exposing a virtual IP address to the Internet 724. Client requests to the servers 728 are scheduled by the load balancer 722. Exemplary load balancing techniques include round robin, weighted round robin with response time as weight, etc.

FIG. 8A shows functional blocks for providing SLB functionality including a classification block 770 receiving data from a receive/ingress block 772. Data from the classification block 770 flows to a load balancing (LB) block 774 or an encapsulation block 776. The classification block 770 performs 5-tuple classification in case of layer 4 SLB and n-tuple classification in case of layer 7 SLB where n is greater than 7. The load balancer block 774 implements load balancing algorithms, such as round robin. The encapsulation block 776 implements an encapsulations for SLB functionality, such as IP NAT (network address translation), IP tunneling or Layer 2 encapsulation. As the packets flow from the ingress block 772 to the classification block 770 a decision is made to send the packet to the encapsulation block 776 if the packet matches a flow in the classification block 770. If a packet does not match any flow in the classification block it is send to the load balancer 774 for assignment to a real server based on the LB algorithm. Thus, all first packets for different flows are sent to the LB block 774. Once a LB decision is made, the LB block 774 will populate appropriate information for the flow in the classification and encapsulation blocks 770, 776 and send the packet to the encapsulation block 776, which performs either IP NAT, IP Tunneling or Layer 2 encapsulation on the packet according to its implementation or LB policy. The packet is then forwarded to the next processing block, such as the transmission/egress block 778.

FIG. 8B shows functional blocks for a Layer 7 SLB implementation where like elements in FIG. 8A have like reference designations. In addition to the functional blocks in FIG. 8A, the layer-7 implementation of FIG. 8B includes a TCP termination block 780 to terminate the TCP connection in order to perform Layer 7 classification on the packet and look at the application level payload such as the HTTP URL and a TCP splicing block 781 to form a TCP connection with the real server once it is determined, since the original TCP connection has been terminated.

Exemplary embodiments of the SLB SAPI allow the control or management application to configure SLB parameters such as the Real, Virtual server IP addresses, port numbers, etc. It also allows the application to configure SLB policies (including different SLB algorithms) for both layer 4 and layer 7 SLB functionality. The interface is asynchronous and also reports SLB related events to the applications.

An illustrative list of operations that could be performed with exemplary SLB interface embodiments is listed below. Note that the SLB table, e.g., SLB table 26 in FIG. 1, can be located in a forwarding plane.
1. SLB Event notification registration.
2. Create SLB Table
3. Delete SLB Table
4. Add Server Pool entries (Real, Virtual Server info) to SLB Table
5. Delete Server Pool entries from SLB Table
6. Purge all Server Pool entries from SLB Table
7. Query Server Pool entries from SLB Table
8. Add SLB Policy entries to SLB Table
9. Delete SLB Policy entries from SLB Table
10. Query SLB Policy entries from SLB Table
11. Purge all SLB Policy entries from SLB Table
12. Query Statistics on per SLB Table basis
13. Query Statistics on per Real Server basis from SLB table
14. Query Statistics on per Virtual Server basis from SLB table

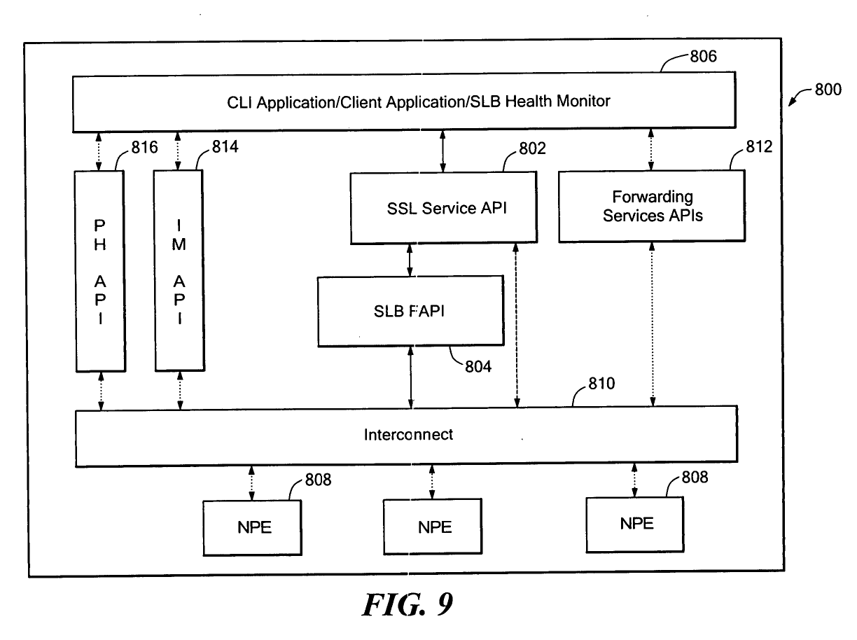

FIG. 9 shows an illustrative API architectural relationship 800. A SLB service API 802 interacts with a SLB FAPI 804 and a client application 806. The SLB Service API 802 and the SLB FAPI 804 communicate with NPEs 808 via an interconnect 810. Forwarding service APIs 812 interact with the client application 806 and the interconnect 810. Further exemplary APIs include an IM API 814 and PH API 816.

Layer 4 SLB services perform load balancing decisions based on the packet header up to Layer 4 (transport layer) in the packet header. An example of a Layer 4 SLB would be a web server SLB which would schedule packets based on their protocol number, i.e. HTTP or HTTPS.

The SLB SAPI described herein is aligned with the requirements set by the NPF NCI Software Framework. The structure and attributes of the SLB API reflect what is needed by the forwarding plane, not by the application. Applications are expected to maintain their own representation of the SLB tables. Memory allocation and usage model for this API implementation will be as dictated by the NPF Software Conventions Implementation Agreement. The SLB SAPI is designed in accordance with the NPF framework design principle. Usually control applications need assistance from a number of APIs. For example, the Operational APIs—such as the Interface Management API might be needed by the SLB applications.

The exemplary embodiments shown and described herein provide generic, standards-based interfaces for configuring network services such as SLB (server load balancing) and SSL acceleration. Use of these interfaces allows interoperability between multiple vendors which in turn facilitates easy integration of these services into different platforms such as ATCA (Advanced Telecom Computing Architecture) and the Intel/IBM Blade Center server platform. This in turn results in quicker time to market, lower total cost of ownership (TCO), better performance by integration of best of breed components as well as better scalability of these systems.

The exemplary interfaces are designed to be completely asynchronous in nature to support any kind of interconnect technology between the control and data planes. Control plane and data plane could be connected using network technology such as Ethernet or Fiber, it could be connected via bus technology such as PCI (Peripheral Component Interconnect) Express, or they could be co-located and be connected via inter-process communication.

An attached Appendix contains exemplary embodiments of an SSL SAPI and a SLB SAPI. It is understood that the illustrative SSL SAPI and SLB SAPI can be modified to meet the needs of a particular application without departing from the exemplary embodiments contained herein.

Other embodiments are within the scope of the following claims.

What is claimed is:

1. A method, comprising:
communicating with a network processing element over an interconnect using computer-readable code for a Secure Socket Layer (SSL) services application programming interface (SAPI) that abstracts manipulation of SSL tables based upon an SSL implementation model.

2. The method according to claim 1, wherein the SSL SAPI is adapted to operate on a control plane and an SSL session is adapted to operate on a forwarding plane.

3. The method according to claim 2, further including manipulating table entries in a table in a forwarding element in the forwarding plane by an SSL application in the control plane via an interconnect by the SSL SAPI in the control plane.

4. The method according to claim 1, wherein the SSL implementation model includes a full offload model.

5. The method according to claim 4, further including communicating, by the SAPI, with an openSSL application below a layer for the SAPI.

6. The method according to claim 4, further including communicating, by the SAPI, with an open SSL application above a layer for the SAPI.

7. The method according to claim 1, wherein the SSL implementation model includes a partial offload model.

8. The method according to claim 1, wherein the SAPI manages session negotiation.

9. An article, comprising;
a storage medium having stored thereon instructions that when executed by a machine result in the following:
communicating with a network processing element over an interconnect using a Secure Socket Layer (SSL) services application programming interface (SAPI) that abstracts manipulation of SSL tables based upon an SSL implementation model.

10. The article according to claim 9, wherein the SSL SAPI is adapted to operate on a control plane and an SSL session is adapted to operate on a forwarding plane.

11. The article according to claim 10, further including instructions to enable manipulating table entries in a table in a forwarding element in the forwarding plane by an SSL application in the control plane via an interconnect by the SSL SAPI in the control plane.

12. The article according to claim 9, wherein the SSL implementation model includes a full offload model.

13. The article according to claim 12, further including instructions to enable communicating, by the SAPI, with an openSSL application below a layer for the SAPI.

14. The article according to claim 12, further including instructions to enable communicating, by the SAPI, with an open SSL application above a layer for the SAPI.

15. The method according to claim 1, wherein the SSL implementation model includes a partial offload model.

16. A method, comprising:
communicating with a network processing element over an interconnect using computer-readable code for a Server Load Balancing (SLB) services API (SAPI) that abstracts manipulation of SLB tables based upon an SLB implementation model.

17. The method according to claim 16, wherein the SLB SAPI is adapted to operate on a control plane and the SLB tables are adapted to operate on a forwarding plane.

18. The method according to claim 17, further including manipulating table entries in a table in a forwarding element in the forwarding plane by an SLB application in the control plane via an interconnect by the SLB SAPI in the control plane.

19. An article, comprising;
a storage medium having stored thereon instructions that when executed by a machine result in the following:
communicating with a network processing element over an interconnect using a Server Load Balancing (SLB) services application programming interface (SAPI) that abstracts manipulation of SLB tables based upon an SSL implementation model.

20. The article according to claim 19, wherein the SLB SAPI is adapted to operate on a control plane and the SLB tables are adapted to operate on a forwarding plane.

21. The article according to claim 20, further including manipulating table entries in a table in a forwarding element in the forwarding plane by an SLB application in the control plane via an interconnect by the SLB SAPI in the control plane.
